(19) United States
(12) Patent Application Publication
(10) Pub. No.: US 2015/0099156 A1
(43) Pub. Date: Apr. 9, 2015

(54) USE FOR RESIN, RESIN COMPOSITION, SEPARATOR FOR NONAQUEOUS-ELECTROLYTE SECONDARY BATTERY, METHOD FOR MANUFACTURING SAID SEPARATOR, AND NONAQUEOUS-ELECTROLYTE SECONDARY BATTERY

(71) Applicant: SUMITOMO CHEMICAL COMPANY, LIMITED, Chuo-ku, Tokyo (JP)

(72) Inventors: Junji Suzuki, Niihama-shi (JP); Chikara Murakami, Osaka-shi (JP)

(73) Assignee: SUMITOMO CHEMICAL COMPANY, LIMITED, Chuo-ku, Tokyo (JP)

(21) Appl. No.: 14/391,191

(22) PCT Filed: Apr. 8, 2013
(86) PCT No.: PCT/JP2013/061132

§ 371 Date: Oct. 8, 2014

(30) Foreign Application Priority Data
Apr. 10, 2012 (JP) 2012-089044

(51) Int. Cl. H01M 2/16; H01M 4/139; H01M 4/04; H01M 2/14; H01M 10/05

(52) U.S. Cl. CPC H01M 2/1653; H01M 2/1686; H01M 2/145; H01M 10/05; H01M 4/0404; H01M 4/139
USPC 429/144; 524/430; 427/126.1

(57) ABSTRACT

The present invention provides a resin (a) as a binder for binding filler particles to a surface of a separator substrate for a nonaqueous-electrolyte secondary battery. The use of this resin (a) makes it possible to give a separator excellent in heat resistance. The resin (a) is a copolymer including a structural unit (1) derived from vinyl alcohol, and a structural unit (2) derived from a metal salt of acrylic acid.

### TECHNICAL FIELD

The present invention relates to the use of resin as a binder for binding filler particles to a surface of a separator substrate for a nonaqueous-electrolyte secondary battery; a resin composition containing the resin and filler particles; a separator for a nonaqueous-electrolyte secondary battery, this separator containing the resin composition; a method for manufacturing the separator; and a nonaqueous-electrolyte secondary battery including the separator.

### BACKGROUND ART

Patent Document 1 states that polyvinyl alcohol is used as a binder for binding filler particles to a surface of a separator substrate for a nonaqueous-electrolyte secondary battery.

However, a separator obtained using, as this binder, polyvinyl alcohol cannot necessarily satisfy heat resistance. An object of the present invention is to provide a separator excellent in heat resistance.

### PRIOR ART DOCUMENT

### Patent Document

Patent Document 1: WO 2008/093575

### DISCLOSURE OF THE INVENTION

The present invention includes the inventions recited in the following items [1] to [15].

[1] Use of the following resin (a) as a binder for binding filler particles to a surface of a separator substrate for a nonaqueous-electrolyte secondary battery:

resin (a): a copolymer comprising a structural unit (1) derived from vinyl alcohol, and a structural unit (2) derived from a metal salt of acrylic acid.

[2] The use of the resin (a), wherein the total content by percentage of the structural units (1) and (2) in the resin (a) is 40% or more by mole of the total of entire structural units constituting the copolymer.
[3] The use of the resin (a), wherein the content by percentage of the structural unit (1) in the resin (a) is from 1 to 90% by mole of the total of the structural units (1) and (2).
[4]A resin composition for treating a surface of a separator substrate for a nonaqueous-electrolyte secondary battery, comprising the following resin (a) and filler particles:

resin (a): a copolymer comprising a structural unit (1) derived from vinyl alcohol, and a structural unit (2) derived from a metal salt of acrylic acid.

[5] The resin composition, wherein the total content by percentage of the structural units (1) and (2) in the resin (a) is 40% or more by mole of the total of entire structural units constituting the copolymer.
[6] The resin composition, wherein the content by percentage of the structural unit (1) in the resin (a) is from 1 to 90% by mole of the total of the structural units (1) and (2).
[7] The resin composition, further comprising a solvent.
[8]A separator for a nonaqueous-electrolyte secondary battery, comprising: a filler layer comprising the following resin (a) and filler particles; and a separator substrate for the nonaqueous-electrolyte secondary battery:

resin (a): a copolymer comprising a structural unit (1) derived from vinyl alcohol, and a structural unit (2) derived from a metal salt of acrylic acid.

[9] The separator, wherein the total content by percentage of the structural units (1) and (2) in the resin (a) is 40% or more by mole of the total of entire structural units constituting the copolymer.
[10] The separator, wherein the content by percentage of the structural unit (1) in the resin (a) is from 1 to 90% by mole of the total of the structural units (1) and (2).
[11] The separator, wherein the separator substrate for the nonaqueous-electrolyte secondary battery is a polyolefin porous membrane.
[12]A method for manufacturing a separator for a nonaqueous-electrolyte secondary battery, comprising the step of applying the resin composition to a surface of a separator substrate.
[13] The manufacturing method, further comprising the step of drying the resultant applied product.
[14] The manufacturing method, wherein the separator substrate for the nonaqueous-electrolyte secondary battery is a polyolefin porous membrane.
[15]A nonaqueous-electrolyte secondary battery, comprising the separator.

When the resin (a) is used as a binder to bind filler particles to a surface of a separator substrate for a nonaqueous-electrolyte secondary battery, a separator excellent in heat resistance is obtained. A nonaqueous-electrolyte secondary battery comprising this separator is excellent in safety.

### MODE FOR CARRYING OUT THE INVENTION

Hereinafter, the present invention will be described in detail.

First, a description is made about the resin (a).

The resin (a) is a copolymer containing a structural unit (1) derived from vinyl alcohol (hereinafter also referred to as “structural unit (1)”), and a structural unit (2) derived from a metal salt of acrylic acid (hereinafter also referred to as “structural unit (2)”). The resin (a) may have a structural unit other than the structural units (1) and (2) (hereinafter the other unit being also referred to as “structural unit (3)”). The total content by percentage of the structural units (1) and (2) is preferably 40% or more by mole, more preferably 50 or more by mole, further preferably 60% or more by mole of the total of entire structural units constituting the copolymer.

The structural unit (1) is represented by the following formula (1):

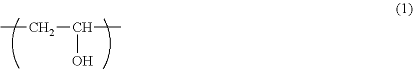

The structural unit (2) is preferably a structural unit derived from an alkali metal salt of acrylic acid, or a structural unit derived from an alkaline earth metal salt of acrylic acid, more preferably a structural unit derived from an alkali metal salt of acrylic acid, further preferably a structural unit derived from a lithium salt of acrylic acid, or a sodium salt of acrylic acid. For example, the structural unit derived from the alkali metal salt of acrylic acid is represented by the following formula (2):

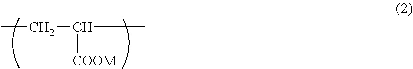

wherein M represents an alkali metal atom.

The content by percentage of the structural unit (1) in the resin (a) is preferably from 1 to 90% by mole, more preferably from 5 to 80% by mole, further preferably from 10 to 70% by mole of the total of the structural units (1) and (2).

The structural unit (3) is, for example, the following: a structural unit derived from a vinyl ester of an aliphatic acid having 2 to 16 carbon atoms, such as vinyl acetate, vinyl propionate, vinyl butyrate, vinyl laurate, vinyl caproate, vinyl stearate, vinyl palmitate, or vinyl versatate; a structural unit derived from an alkyl acrylate having an alkyl group having 1 to 16 carbon atoms, such as methyl acrylate, ethyl acrylate, propyl acrylate, butyl acrylate, hexyl acrylate, octyl acrylate or lauryl acrylate; a structural unit derived from an alkyl methacrylate having an alkyl group having 1 to 16 carbon atoms, such as ethyl methacrylate, propyl methacrylate, butyl methacrylate, hexyl methacrylate, octyl methacrylate, or lauryl methacrylate; a structural unit derived from a dialkyl maleate having alkyl groups each having 1 to 16 carbon atoms, such as dimethyl maleate, diethyl maleate, dibutyl maleate, dioctyl maleate, or dilauryl maleate; a structural unit derived from a dialkyl fumarate having alkyl groups each having 1 to 16 carbon atoms, such as dimethyl fumarate, diethyl fumarate, dibutyl fumarate, dioctyl fumarate, or dilauryl fumarate; or a structural unit derived from a dialkyl itaconate having alkyl groups each having 1 to 16 carbon atoms, such as diethyl itaconate, dibutyl itaconate, dihexyl itaconate, dioctyl itaconate, or dilauryl itaconate. The structural unit (3) is preferably a structural unit derived from a vinyl ester of an aliphatic acid having 2 to 16 carbon atoms, or a structural unit derived from an alkyl acrylate having an alkyl group having 1 to 16 carbon atoms, more preferably a structural unit derived from a vinyl ester of an aliphatic acid having 2 to 4 carbon atoms, or a structural unit derived from an alkyl acrylate having an alkyl group having 1 to 4 carbon atoms, further preferably a structural unit derived from vinyl acetate, or a structural unit derived from methyl acrylate.

The resin (a) can be produced in accordance with, for example, a method described in JP-A-52-107096 or JP-A-52-27455. Specifically, the resin (a) can be produced by a producing method including the step of polymerizing a vinyl ester of an aliphatic acid, an alkyl acrylate, and an optionally contained compound from which the structural unit (3) is derived (the compound being other than all vinyl esters of any aliphatic acid, and all alkyl acrylates) (the step being also referred to as the “polymerizing step” hereinafter), and the step of saponifying the resultant polymer (the step being also referred to as the “saponifying step” hereinafter).

In the saponifying step, a structural unit derived from the vinyl ester of the aliphatic acid is saponified into the structural unit (1), and a structural unit derived from the alkyl acrylate is saponified into the structural unit (2). Therefore, by adjusting the individual saponification degrees, or neutralizing the resultant after the saponification, the structural unit derived from the vinyl ester of the aliphatic acid, the structural unit derived from the alkyl acrylate or the structural unit derived from acrylic acid can be incorporated, as the structural unit (3), into the resin (a).

Of course, the structural unit (3) can be incorporated into the resin (a) in accordance with the use amount of the compound from which the structural unit (3) is derived (the compound being other than all vinyl esters of any aliphatic acid, and all alkyl acrylates) in the polymerizing step, the polymerization degree thereof, and/or some other factors.

As described above, the content by percentage of the structural units (1) and (2) is adjustable into the above-mentioned range by appropriately selecting conditions for the polymerizing step and the saponifying step.

The following will describe the use of the resin (a) as a binder for binding filler particles to a surface of a separator substrate for a nonaqueous-electrolyte secondary battery.

Such a use is attained by, for example, a substrate-surface-treating method including the step of applying a resin composition including a resin (a) and filler particles to a surface of a separator substrate for a nonaqueous-electrolyte secondary battery. Preferably, this surface-treating method further includes the step of drying the resultant applied product. Each of the steps of this surface-treating method is the same as each of steps of a method that will be described later for manufacturing a separator.

### <Resin Composition for Treating Surface of Separator Substrate for Nonaqueous-Electrolyte Secondary Battery (Also Referred to as “Resin Composition” in the Present Specification)>

As described above, the resin composition of the present invention contains a resin (a) and filler particles.

Preferably, this composition further contains a solvent.

The filler particles may be fine particles of an inorganic substance, or fine particles of an organic substrate. Examples of the inorganic substance fine particles include calcium carbonate, talc, clay, kaolin, silica, hydrotalcite, diatomaceous earth, magnesium carbonate, barium carbonate, calcium sulfate, magnesium sulfate, barium sulfate, aluminum hydroxide, magnesium hydroxide, calcium oxide, magnesium oxide, titanium oxide, alumina, mica, zeolite and glass. Examples of the organic substance fine particles include homopolymers each made from any one of the following or copolymers each made from two or more of the following: styrene, vinyl ketone, acrylonitrile, methyl methacrylate, ethyl methacrylate, glycidyl methacrylate, glycidyl acrylate, methyl acrylate, and others; fluororesins such as polytetrafluoroethylene, tetrafluoroethylene/hexafluoropropylene copolymer, tetrafluoroethylene/ethylene copolymer, and polyvinylidene fluoride; melamine resins; urea resins; polyethylenes; polypropylenes; and polymethacrylates. The filler particles may be a mixture of fine particles of two or more species, or a mixture of fine particles that are of the same species but have different particle size distributions. For the filler particles, preferred is alumina out of these species. The average particle size of the filler particles is preferably 3 μm or less, more preferably 1 μm or less. The average particle size referred to herein is the average of the primary particle size thereof that is gained through SEM (scanning electron microscope) observation.

The use amount of the filler particles is preferably from 1 to 1000 parts by weight, more preferably from 10 to 100 parts by weight for 1 part by weight of the resin (a). If the use amount of the filler particles is too small, the resultant separator is lowered in gas permeability so that the degree of ion permeation therein may be unfavorably lowered to cause a battery to be lowered in load characteristic. If the use amount of the filler particles is too large, the resultant separator may be unfavorably declined in dimensional stability.

The solvent may be, for example, water or an oxygen-containing organic compound having a boiling point of 50 to 350° C. under normal pressure. Specific examples of the oxygen-containing organic compound include compounds each having an alcoholic hydroxyl group, such as methanol, ethanol, n-propyl alcohol, isopropyl alcohol, n-butyl alcohol, isobutyl alcohol, s-butyl alcohol, amyl alcohol, isoamyl alcohol, methylisobutyl carbinol, 2-ethylbutanol, 2-ethylhexanol, cyclohexanol, furfuryl alcohol, tetrahydrofurfuryl alcohol, ethylene glycol, hexylene glycol and glycerin; saturated aliphatic ether compounds such as propyl ether, isopropyl ether, butyl ether, isobutyl ether, n-amyl ether, isoamyl ether, methyl butyl ether, methyl isobutyl ether, methyl n-amyl ether, methyl isoamyl ether, ethyl propyl ether, ethyl isopropyl ether, ethyl butyl ether, ethyl isobutyl ether, ethyl n-amyl ether, and ethyl isoamyl ether; unsaturated aliphatic ether compounds such as allyl ether and ethyl allyl ether; aromatic ether compounds such as anisole, phenetole, phenyl ether and benzyl ether; cyclic ether compounds such as tetrahydrofuran, tetrahydropyran and dioxane; ethylene glycol ether compounds such as ethylene glycol monomethyl ether, ethylene glycol monoethyl ether, ethylene glycol monobutyl ether, diethylene glycol monomethyl ether, diethylene glycol monoethyl ether, and diethylene glycol monobutyl ether; monocarboxylic acid compounds such as formic acid, acetic acid, acetic anhydride, acrylic acid, citric acid, propionic acid, and butyric acid; organic acid ester compounds such as butyl formate, amyl formate, propyl acetate, isopropyl acetate, butyl acetate, s-butyl acetate, amyl acetate, isoamyl acetate, 2-ethylhexyl acetate, cyclohexyl acetate, butylcyclohexyl acetate, ethyl propionate, butyl propionate, amyl propionate, butyl butyrate, diethyl carbonate, diethyl oxalate, methyl lactate, ethyl lactate, butyl lactate, and triethyl phosphate; ketone compounds such as acetone, ethyl ketone, propyl ketone, butyl ketone, methyl isopropyl ketone, methyl isobutyl ketone, diisobutyl ketone, acetylacetone, diacetone alcohol, cyclohexanone, cyclopentanone, methylcyclohexanone, and cycloheptanone; dicarboxylic acid compounds such as succinic acid, glutaric acid, adipic acid, undecanoic diacid, pyruvic acid, and citraconic acid; and other oxygen-containing organic compounds such as 1,4-dioxane, furfural, and N-methylpyrrolidone.

A solvent is usable in which water and an oxygen-containing organic compound are blended with each other. About the blend ratio between water and the oxygen-containing organic compound, the amount of the oxygen-containing organic compound is preferably from 0.1 to 100 parts by weight, more preferably from 0.5 to 50 parts by weight, further preferably from 1 to 20 parts by weight for 100 parts by weight of water.

The use amount of the solvent is not particularly limited, and is sufficient to be such an amount that the resin composition can obtain the property of being easily appliable onto a polyolefin substrate that will be later described. The solvent is incorporated to set the amount thereof into a range of preferably from 1 to 1000 parts by weight, more preferably from 2 to 500 parts by weight, further preferably from 3 to 300 parts by weight, further more preferably from 5 to 200 parts by weight for 1 part by weight of the resin (a).

The resin composition of the present invention may contain a dispersing agent, a plasticizer, a surfactant, a pH adjustor, an inorganic salt and/or others as far as the object of the present invention is not damaged.

Of these additives, the surfactant is preferably a surfactant which can improve the composition in wettability onto the polyolefin substrate, and examples thereof include products NOPCOWET (registered trademark) 50 and SN WET 366 (each manufactured by San Nopco Limited).

The resin composition of the present invention may be produced by any method. Examples thereof include a method of mixing the filler particles with the resin (a), and then adding the solvent thereto; a method of mixing the filler particles with the solvent, and then adding the resin (a) thereto; a method of adding the filler particles, the resin (a) and the solvent simultaneously to be mixed with each other; and a method of mixing the resin (a) with the solvent, and then adding the filler particles thereto.

### <Separator for Nonaqueous-Electrolyte Secondary Battery (Also Referred to as “Separator” in the Present Specification)>

The separator of the present invention includes: a filler layer including the resin (a) and filler particles; and a separator substrate for a nonaqueous-electrolyte secondary battery (the separator substrate being also referred to as the “substrate” in the specification). Specifically, the separator is a laminated product including a layer including the resin (a) and filler particles (this layer being also referred to as the “filler layer” in the specification); and a layer of the substrate, preferably a laminated product made only of the substrate layer and the filler layer.

Examples of the substrate include a thermoplastic resin such as a polyolefin, paper obtained by papermaking from viscose rayon, natural cellulose or some other, mixed paper obtained by papermaking from fibers such as cellulose and polyester, electrolytic paper, craft paper, Manila paper, a Manila hemp sheet, glass fiber, porous polyester, aramid fiber, polybutylene terephthalate nonwoven fabric, para-type wholly aromatic polyamide, and an unwoven fabric or porous membrane made of a fluorine-contained resin such as vinylidene fluoride, tetrafluoroethylene, a copolymer made from vinylidene fluoride and hexafluoropropylene, or fluorine-contained rubber.

The substrate is preferably a porous membrane of a polyolefin, which preferably contains a high molecular weight component having a weight-average molecular weight of 5×10⁵ to 15×10⁶. Examples of the polyolefin include homopolymers or copolymers each made from, for example, ethylene, propylene, 1-butene, 4-methyl-1-pentene and/or 1-hexene. Of these polymers, preferred is a copolymer made mainly from ethylene, or a homopolymer made from ethylene. More preferred is a homopolymer made from ethylene, that is, polyethylene.

The porosity of the substrate is preferably from 30 to 80% by volume, more preferably from 40 to 70% by volume. If the porosity is less than 30% by volume, the substrate may become small in electrolyte-holding capacity. If the porosity is more than 80% by volume, the substrate or separator may insufficiently become poreless at high temperatures at which this member undergoes shutdown. The pore diameter is preferably 3 μm or less, more preferably 1 μm or less.

The thickness of the substrate is preferably from 5 to 50 μm, more preferably from 5 to 30 μm. If the thickness is less than 5 μm, the substrate or separator may insufficiently become poreless at high temperatures at which this member undergoes shutdown. If the thickness is more than 50 μm, the thickness of the whole of the separator of the present invention becomes large so that the resultant battery may become small in electrical capacity.

This substrate may be a commercially available product having the above-mentioned properties. The method for producing the substrate is not particularly limited, and may be any known method. The method is, for example, a method of adding a plasticizer into a thermoplastic resin, shaping the resultant into a film, and then removing the plasticizer with an appropriate solvent, as described in JP-A-07-29563, or a method of selectively drawing, about a film made of a thermoplastic resin, its amorphous regions which are structurally weak, to form fine pores, as described in JP-A-07-304110.

The thickness of the filler layer is preferably from 0.1 to 10 μm or less. If the thickness is less than 5 μm, the separator may insufficiently become poreless at high temperatures at which the separator undergoes shutdown. If the thickness is more than 10 μm, the resultant nonaqueous-electrolyte secondary battery may be lowered in load characteristic.

The separator of the present invention may contain, for example, an adhesive layer, a protective layer or any other porous membrane layer other than the substrate layer and the filler layer unless the performance of the resultant nonaqueous-electrolyte secondary battery is damaged.

The value of the gas permeability of the separator of the present invention is preferably from 50 to 2000 seconds/100 cc, more preferably from 50 to 1000 seconds/100 cc. As the value of the gas permeability is smaller, the resultant nonaqueous-electrolyte secondary battery is made better in load characteristic to be more preferred. However, if the value is less than 50 seconds/100 cc, the separator may insufficiently become poreless at high temperatures at which the separator undergoes shutdown. If the value of the gas permeability is more than 2000 seconds/100 cc, the resultant nonaqueous-electrolyte secondary battery may be lowered in load characteristic.

### <Method for Manufacturing Separator>

The method of the present invention for manufacturing a separator may be performed, for example, in a manner including the steps of: applying the resin composition of the invention onto a support other than the above-defined substrate to yield a laminated product comprising the support and a filler layer; drying the resultant laminated product; separating the filler layer and the support from the dried laminated product; and bonding the resultant filler layer onto a substrate under pressure. Preferably, the manufacturing method is performed in a manner including the step of applying the resin composition of the present invention onto a surface of a substrate to yield a laminated product comprising the substrate and a filler layer. More preferably, the manufacturing method further includes the step of drying the resultant laminated product. Before the applying of the resin composition of the invention onto the surface of the substrate, the substrate may be beforehand subjected to corona treatment.

The method for applying the resin composition of the invention onto the surface of the substrate, or the support other than the substrate may be performed through an industrially ordinarily performed manner, for example, a manner based on applying using a coater (also called a doctor blade), or on applying using a brush. The thickness of the filler layer can be controlled by adjusting the thickness of the applied membrane, the concentration of the resin (a) in the resin composition, the quantity ratio between the filler particles and the resin (a), and/or other factors. The support other than the substrate may be, for example, a film made of resin, or a belt or drum made of metal.

In the present invention, the wording “drying the laminated product” denotes that the solvent contained mainly in the filler layer of the laminated product (the solvent being also referred to as the “solvent (b)” hereinafter) is removed. The drying is attained by vaporizing the solvent (b) from the filler layer through, for example, a heating unit using a heating device such as a hot plate or a pressure-reducing unit using a pressure-reducing device, or a combination of these units. Conditions for the heating unit or pressure-reducing unit may be appropriately selected in accordance with the species of the solvent (b), and/or other factors as far as the substrate layer is not lowered in gas permeability. In the case of, for example, a hot plate, it is preferred to adjust the surface temperature of the hot plate to the melting point of the substrate layer, or lower. About the pressure-reducing unit, it is advisable to seal the laminated product into an appropriate pressure-reducing machine, and then adjust the pressure inside the pressure-reducing machine into the range of about 1 to 1.0×10⁵ Pa. Another method is also usable that makes use of a solvent which is soluble in the solvent (b) and does not dissolve the used resin (a) (this solvent being also referred to as the “solvent (c)” hereinafter). The filler layer of the laminated product is immersed in the solvent (c). Thus, the solvent (b) is substituted with the solvent (c) so that the resin (a) dissolved in the solvent (b) precipitates. Next, the solvent (c) is removed by drying.

### <Nonaqueous-Electrolyte Secondary Battery (Also Referred to as “Battery” Hereinafter)>

The battery of the present invention includes the separator of the present invention. The following will describe its constituents other than the separator of the invention, giving, as an example, a case where the battery of the invention is a lithium ion secondary battery. However, the constituents are not limited to these described elements.

Any lithium ion secondary battery is, for example, a battery including electrodes (positive electrode and negative electrode), an electrolyte, a separator and others, in which lithium is oxidized and reduced between the two electrodes of the positive and negative electrodes to store and discharge electrical energy.

### (Electrodes)

The electrodes are positive and negative electrodes for a secondary battery. The electrodes are each usually in a state that an electrode active material and an optional conductor are applied through a binder onto at least one surface of a current collector (preferably, both surfaces thereof).

The electrode active material is preferably an active material capable of occluding and emitting lithium ions. The electrode active material is classified into a positive electrode active material and a negative electrode active material.

The positive electrode active material is, for example, a metal multiple oxide, in particular, a metal multiple oxide containing lithium, and at least one or more of iron, cobalt, nickel and manganese; and is preferably an active material containing LiₓMO₂ wherein M represents one or more transition metals, preferably at least one of Co, Mn or Ni; and 1.10>x>0.05, or LiₓM₂O₄ wherein M represents one or more transition metals, preferably Mn; and 1.10>x>0.05. Examples thereof include multiple oxides represented by LiCoO₂, LiNiO₂, LiₓNi_{y}Co_{(1-y)}O₂ wherein 1.10>x>0.05 and 1>y>0, and LiMn₂O₄, respectively.

Examples of the negative electrode active material include various silicon oxides (such as SiO₂), carbonaceous substances, and metal multiple oxides. Preferred examples thereof include carbonaceous substances, such as amorphous carbon, graphite, natural graphite, MCMB, pitch-based carbon fiber, and polyacene; multiple metal oxides each represented by AₓM_{y}O_{z} wherein A represents Li; M represents at least one selected from Co, Ni, Al, Sn and Mn; O represents an oxygen atom; and x, y and z are numbers satisfying the following ranges, respectively: 1.10≧x≧0.05, 4.00≧y≧0.85, and 5.00≧z≧1.5; and other metal oxides.

Examples of the above-mentioned conductor include conductive carbons such as graphite, carbon black, acetylene black, Ketjen black, and activated carbon; graphite type conductors such as natural graphite, thermally expanded graphite, scaly graphite, and expanded graphite; carbon fibers such as vapor-phase-grown carbon fiber; fine metal particles or metal fiber made of aluminum, nickel, copper, silver, gold, platinum or some other metal; conductive metal oxides such as ruthenium oxide and titanium oxide; and conductive polymers such as polyaniline, polypyrrole, polythiophene, polyacetylene, and polyacene.

Preferred are carbon black, acetylene black, and Ketjen black since a small amount thereof makes an effective improvement of the electrodes in electroconductivity.

The content of the conductor is, for example, preferably from 0 to 50 parts by weight, more preferably from 0 to 30 parts by weight for 100 parts by weight of each of the electrode active materials.

The material of the current collector is, for example, a metal such as nickel, aluminum, titanium, copper, gold, silver, platinum, aluminum alloy or stainless steel; a product formed by plasma-spraying or arc-spraying nickel, aluminum, zinc, copper, tin or lead, or an alloy of two or more of these metals thermally onto a carbon material or an activated carbon fiber; a conductive film in which a conductor is dispersed in a rubber or a resin such as styrene/ethylene/butylene/styrene copolymer (SEBS); or some other.

The shape or form of the current collector is, for example, a foil piece, flat plate, mesh, net, lath, punched or embossed shape or form, or a combination of two or more thereof (for example, a mesh-form flat plate).

Irregularities may be formed in the surface of the current collector by etching treatment.

Examples of the above-mentioned binder include fluorine-contained polymers such as polyvinylidene fluoride; diene polymers such as polybutadiene, polyisoprene, isoprene/isobutylene copolymer, natural rubber, styrene/1,3-butadiene copolymer, styrene/isoprene copolymer, 1,3-butadiene/isoprene/acrylonitrile copolymer, styrene/1,3-butadiene/isoprene copolymer, 1,3-butadiene/acrylonitrile copolymer, styrene/acrylonitrile/1,3-butadiene/methyl methacrylate copolymer, styrene/acrylonitrile/1,3-butadiene/itaconic acid copolymer, styrene/acrylonitrile/1,3-butadiene/methyl methacrylate/fumaric acid copolymer, styrene/1,3-butadiene/itaconic acid/methyl methacrylate/acrylonitrile copolymer, acrylonitrile/1,3-butadiene/methacrylic acid/methyl methacrylate copolymer, styrene/1,3-butadiene/itaconic acid/methyl methacrylate/acrylonitrile copolymer, and styrene/acrylonitrile/1,3-butadiene/methyl methacrylate/fumaric acid copolymer; olefin based polymers such as ethylene/propylene copolymer, ethylene/propylene/diene copolymer, polystyrene, polyethylene, polypropylene, ethylene/vinyl acetate copolymer, ethylene based ionomer, polyvinyl alcohol, vinyl acetate polymer, ethylene/vinyl alcohol copolymer, chlorinated polyethylene, polyacrylonitrile, polyacrylic acid, polymethacrylic acid, and chlorosulfonated polyethylene; styrene based polymers such as styrene/ethylene/butadiene copolymer, styrene/butadiene/propylene copolymer, styrene/isoprene copolymer, styrene/n-butyl acrylate/itaconic acid/methyl methacrylate/acrylonitrile copolymer, and styrene/n-butyl acrylate/itaconic acid/methyl methacrylate/acrylonitrile copolymer; acrylate based polymers such as polymethyl methacrylate, polymethyl acrylate, polyethyl acrylate, polybutyl acrylate, acrylate/acrylonitrile copolymer, and 2-ethylhexyl acrylate/methyl acrylate/acrylic acid/methoxypolyethylene glycol monomethacrylate; polyamide or polyimide based polymers such as polyamide 6, polyamide 66, polyamide 11, polyamide 12, aromatic polyamide, and polyimide; ester based polymers such as polyethylene terephthalate, and polybutylene terephthalate; cellulose based polymers (and salts thereof, such as ammonium salts and alkali metal salts thereof) such as carboxymethylcellulose, carboxyethylcellulose, ethylcellulose, hydroxymethylcellulose, hydroxypropylcellulose, and carboxyethylmethylcellulose; styrene/butadiene block copolymer, styrene/butadiene/styrene block copolymer, styrene/ethylene/butylene/styrene block copolymer, styrene/isoprene block copolymer, styrene/ethylene/propylene/styrene block copolymer and other block copolymers, ethylene/vinyl chloride copolymer, and ethylene/vinyl acetate copolymer; methyl methacrylate polymer and other polymers.

### (Electrolyte)

The electrolyte used in the lithium ion secondary battery may be, for example, a nonaqueous electrolyte in which a lithium salt is dissolved in an organic solvent. The lithium salt may be one made of the following or a mixture of two or more of the following: LiClO₄, LiPF₆, LiAsF₆, LiSbF₆, LiBF₄, LiCF₃SO₃, LiN(SO₂CF₃)₂, LiC(SO₂CF₃)₃, Li₂B₁₀Cl₁₀, respective lithium salts of lower aliphatic carboxylic acids, and LiAlCl₄.

The lithium salt preferably includes, out of these salts, at least one selected from the group consisting of LiPF₆, LiAsF₆, LiSbF₆, LiBF₄, LiCF₃SO₃, LiN(CF₃SO₂)₂, and LiC(CF₃SO₂)₃, each of which contains fluorine.

Examples of the organic solvent used in the electrolyte include carbonates such as propylene carbonate, ethylene carbonate, dimethyl carbonate, diethyl carbonate, ethylmethyl carbonate, 4-trifluoromethyl-1,3-dioxolane-2-one, and 1,2-di(methoxycarbonyloxy)ethane; ethers such as 1,2-dimethoxyethane, 1,3-dimethoxypropane, pentafluoropropyl methyl ether, 2,2,3,3-tetrafluoropropyl difluoromethyl ether, tetrahydrofuran, and 2-methyltetrahydrofuran; esters such as methyl formate, methyl acetate, and γ-butyrolactone; nitriles such as acetonitrile, and butyronitrile; amides such as N,N-dimethylformamide, N,N-dimethylacetoamide; carbamates such as 3-methyl-2-oxazolidone; sulfur-containing compounds such as sulfolane, dimethylsulfoxide, and 1,3-propanesultone; and compounds each obtained by introducing a fluorine substituent into any one of these organic solvents. Usually, two or more of these solvents are used in a mixture form.

The shape or form of the battery of the present invention is not particularly limited. Examples thereof include a laminated form, a coin form, a cylindrical form and a prismatic form.

Hereinafter, the present invention will be described by way of working examples thereof; however, the invention is not limited to these examples.

About each of the working examples, comparative examples and reference examples that will be described below, individual physical properties of its separator were measured by the following methods:

(1) Dimension retaining percentage: The separator was cut into a piece 5 cm square. At the center thereof, guide lines were drawn into a 4 cm square form, and then the piece was sandwiched between two pieces of paper. The workpiece was held in an oven of 150° C. temperature for 1 hour, and then taken away. The dimensions of the square were measured to calculate the dimension retaining percentage thereof.

The method for calculating the dimension retaining percentage is as follows:

The length of any one of the guide lines in the machine direction (MD) before the heating: L1,

The length of any one of the guide lines in the transverse direction (TD) before the heating: W1,

The length of the guide line in the machine direction (MD) after the heating: L2, and

The length of the guide line in the transverse direction (TD) after the heating: W2;

The dimension retaining percentage (%) in the machine direction (MD)=L2/L1×100, and

The dimension retaining percentage (%) in the transverse direction (TD)=W2/W1×100.

(2) Gas permeability: The property was in accordance with JIS P8117.

### Reference Example 1

### Polyethylene Porous Membrane

Prepared was a substance composed of 70% by weight of an ultra high molecular weight polyethylene powder (340M, manufactured by Mitsui Chemicals, Inc.) and 30% by weight of a polyethylene wax having a weight-average molecular weight of 1000 (FNP-0115, manufactured by Nippon Seiro Co., Ltd.). The following were added to total 100 parts by weight of the ultra high molecular weight polyethylene and the polyethylene wax: 0.4 part by weight of an antioxidant (Irg 1010, manufactured by Ciba Specialty Chemicals); 0.1 part by weight of an antioxidant (P168, manufactured by Ciba Specialty Chemicals); and 1.3 parts by weight of sodium stearate. To the resultant composition was further added calcium carbonate having an average particle diameter of 0.1 μm (manufactured by Maruo Calcium Co., Ltd.) to give a volume of 38% of the total volume of the composition. These components were mixed with each other while kept in a powdery form, using a Henschel mixer. The mixture was then melt-kneaded in a biaxial kneader to prepare a polyolefin resin composition. The polyolefin resin composition was rolled between a pair of rolls having a surface temperature of 150° C. to produce a sheet. This sheet was immersed in an aqueous solution of hydrochloric acid (hydrochloric acid: 4 mol/L, and nonionic surfactant: 0.5% by weight) to remove calcium carbonate, and subsequently the sheet was drawn 6 times at 105° C. and then subjected to corona treatment at 50 W/(m²/minute) to yield a porous substrate film (thickness: 16.6 μm) which was a porous membrane made of polyethylene.

### Example 1

Water was added to the following mixture to set the solid content by percentage therein to 23% by weight: a mixture of 100 parts by weight of fine alumina particles (trade name “AKP 3000” manufactured by Sumitomo Chemical Co., Ltd.); 3 parts by weight of a vinyl alcohol/sodium acrylate copolymer (copolymerization ratio: vinyl alcohol/sodium acrylate=60/40); and 34 parts by weight of isopropyl alcohol. The resultant mixture was stirred and mixed in a rotation/revolution mixer. The resultant mixture was stirred and mixed in a thin-film revolution type high-speed mixer (FILMIX (registered trademark) manufactured by PRIMIX Corporation) to yield a composition of the present invention as a homogeneous slurry. A Multi Lab coater was used to apply this composition evenly onto a single surface of the porous substrate film yielded in Reference Example 1. The resultant applied product was dried in a drier of 60° C. temperature for 5 minutes to yield a separator for a nonaqueous-electrolyte secondary battery.

About the resultant separator, the thickness was 25.4 μm, the weight per unit area was 7.44 g/m² (the porous polyethylene film: 6.72 g/m²; the vinyl alcohol/sodium acrylate copolymer: 0.22 g/m²; and the alumina: 7.22 g/m²).

Its individual physical properties are as follows:

(1) Dimension retaining percentage: 98% in the MD direction, and 98% in the TD direction
(2) Gas permeability: 84 seconds/100 cc

### Example 2

A separator for a nonaqueous-electrolyte secondary battery was yielded in the same way as in Example 1 except the use of 2 parts by weight of a vinyl alcohol/sodium acrylate copolymer (copolymerization ratio: vinyl alcohol/sodium acrylate=70/30). Individual properties thereof are shown in Table 1.

### Example 3

A separator for a nonaqueous-electrolyte secondary battery was yielded in the same way as in Example 2 except the use of 3 parts by weight of a vinyl alcohol/sodium acrylate copolymer (copolymerization ratio: vinyl alcohol/sodium acrylate=70/30). Individual properties thereof are shown in Table 1.

### Example 4

A separator for a nonaqueous-electrolyte secondary battery was yielded in the same way as in Example 1 except the use of 2 parts by weight of a vinyl alcohol/sodium acrylate copolymer (copolymerization ratio: vinyl alcohol/sodium acrylate=50/50). Individual properties thereof are shown in Table 1.

### Example 5

A separator for a nonaqueous-electrolyte secondary battery was yielded in the same way as in Example 4 except the use of 3 parts by weight of a vinyl alcohol/sodium acrylate copolymer (copolymerization ratio: vinyl alcohol/sodium acrylate=50/50). Individual properties thereof are shown in Table 1.

### Example 6

A separator for a nonaqueous-electrolyte secondary battery was yielded in the same way as in Example 1 except the use of 3 parts by weight of a vinyl alcohol/sodium acrylate copolymer (copolymerization ratio: vinyl alcohol/sodium acrylate=20/80). Individual properties thereof are shown in Table 1.

### Comparative Example 1

A separator for a nonaqueous-electrolyte secondary battery was yielded in the same way as in Example 1 except that instead of the vinyl alcohol/sodium acrylate copolymer in Example 1, a polyvinyl alcohol (Wako first class, manufactured by Wako Pure Chemical Industries, Ltd.; average polymerization degree: 3100 to 3900, and saponification degree: 86 to 90% by mole) was added in an amount of 3 parts. Individual properties of the resultant separator are shown in Table 1.

TABLE 1

| | | | | | | Dimension retaining | | |
|---|---|---|---|---|---|---|---|---|
| | | | The number | | Filler layer | percentage | | Gas |
| | | | of parts | Filler layer | weight per | MD | TD | permeability |
| | Structural | Structural | of binder | thickness | unit area | direction | direction | Seconds/ |
| Resin (a) | unit (1) | unit (2) | [parts] | [μm] | [g/m2] | [%] | [%] | 100 cc |
| Vinyl | 60 | 40 | 3 | 8.8 | 7.4 | 95≦ | 95≦ | 84 |
| alcohol/ | 70 | 30 | 2 | 4.9 | 7.7 | 67 | 74 | 84 |
| sodium | | | 3 | 5.2 | 7.5 | 95≦ | 95≦ | 86 |
| acrylate | 50 | 50 | 2 | 4.8 | 7.8 | 88 | 94 | 85 |
| copolymer | | | 3 | 5.3 | 7.8 | 95≦ | 95≦ | 85 |
| | 20 | 80 | 3 | 6.0 | 6.5 | 95≦ | 95≦ | 83 |
| Polyvinyl | 100 | 0 | 3 | 5.5 | 7.6 | 25 | 33 | 89 |
| alcohol | | | | | | | | |

It can be mentioned that as such a separator is higher in dimension retaining percentage, the separator is better in heat resistance.

### INDUSTRIAL APPLICABILITY

When the above-mentioned resin (a) is used as a binder for binding filler particles to a surface of a separator substrate for a nonaqueous-electrolyte secondary battery, a separator excellent in heat resistance can be obtained. A nonaqueous-electrolyte secondary battery including this separator is excellent in safety.

1. Use of the following resin (a) as a binder for binding filler particles to a surface of a separator substrate for a nonaqueous-electrolyte secondary battery:
resin (a): a copolymer comprising a structural unit (1) derived from vinyl alcohol, and a structural unit (2) derived from a metal salt of acrylic acid.

2. The use of the resin (a) according to claim 1, wherein the total content by percentage of the structural units (1) and (2) in the resin (a) is 40% or more by mole of the total of entire structural units constituting the copolymer.

3. The use of the resin (a) according to claim 1, wherein the content by percentage of the structural unit (1) in the resin (a) is from 1 to 90% by mole of the total of the structural units (1) and (2).

4. A resin composition for treating a surface of a separator substrate for a nonaqueous-electrolyte secondary battery, comprising the following resin (a) and filler particles:
resin (a): a copolymer comprising a structural unit (1) derived from vinyl alcohol, and a structural unit (2) derived from a metal salt of acrylic acid.

5. The resin composition according to claim 4, wherein the total content by percentage of the structural units (1) and (2) in the resin (a) is 40% or more by mole of the total of entire structural units constituting the copolymer.

6. The resin composition according to claim 4, wherein the content by percentage of the structural unit (1) in the resin (a) is from 1 to 90% by mole of the total of the structural units (1) and (2).

7. The resin composition according to claim 4, further comprising a solvent.

8. A separator for a nonaqueous-electrolyte secondary battery, comprising: a filler layer comprising the following resin (a) and filler particles; and a separator substrate for the nonaqueous-electrolyte secondary battery:
resin (a): a copolymer comprising a structural unit (1) derived from vinyl alcohol, and a structural units (2) derived from a metal salt of acrylic acid.

9. The separator according to claim 8, wherein the total content by percentage of the structural units (1) and (2) in the resin (a) is 40% or more by mole of the total of entire structural units constituting the copolymer.

10. The separator according to claim 8, wherein the content by percentage of the structural unit (1) in the resin (a) is from 1 to 90% by mole of the total of the structural units (1) and (2).

11. The separator according to claim 8, wherein the separator substrate for the nonaqueous-electrolyte secondary battery is a polyolefin porous membrane.

12. A method for manufacturing a separator for a nonaqueous-electrolyte secondary battery, comprising the step of applying the resin composition according to claim 4 to a surface of a separator substrate.

13. The manufacturing method according to claim 12, further comprising the step of drying the resultant applied product.

14. The manufacturing method according to claim 12, wherein the separator substrate for the nonaqueous-electrolyte secondary battery is a polyolefin porous membrane.

15. A nonaqueous-electrolyte secondary battery, comprising the separator according to claim 8.
